(19) United States
(12) Patent Application Publication
(10) Pub. No.: US 2016/0369972 A1
(43) Pub. Date: Dec. 22, 2016

(54) LIGHT-EMITTING DEVICE

(71) Applicant: KONINKLIJKE PHILIPS N.V., Eindhoven (NL)

(72) Inventors: JOHANNES MARIA THIJSSEN, BEST (NL); SILVIA MARIA BOOIJ, EINDHOVEN (NL)

(21) Appl. No.: 14/901,843

(22) PCT Filed: Jul. 1, 2014
(86) PCT No.: PCT/EP2014/063888

§ 371 Date: Dec. 29, 2015

(30) Foreign Application Priority Data
Jul. 4, 2013 (EP) 13175043.2

(51) Int. Cl. F21V 7/00; F21S 8/04; F21V 7/06; F21K 9/62; E04B 9/00; F21V 7/22

(52) U.S. Cl. CPC F21V 7/0033; E04B 9/001; F21V 7/22; F21V 7/06; F21V 7/005; F21K 9/62; F21S 8/04; F21V 7/0008; F21Y 2115/10

(57) ABSTRACT

There is provided a light-emitting device (1) that may be mounted in a ceiling. The light-emitting device (1) comprises an optically reflecting layer (11) and a light-transmissive layer (12) arranged such that a space is formed in-between. In the space a light source (10a, 10b) and a reflector (13a, 13b) are arranged such that light emitted by the light source (10a, 10b) is redirected by the reflector (13a, 13b) and emitted primarily towards a reflective side (14) of the optically reflecting layer (11). The reflector (13a, 13b) is arranged to emit a portion of the light directly towards the light-transmissive layer (12). Furthermore, the reflector (13a, 13b) may comprise optically specular portions (20a, 20b, 31) and optically diffusive portions (18, 32, 33, 34, 35) arranged such that a larger surface fraction of the reflector (13a, 13b) comprises diffusive surface portions closer to the optically reflecting layer (11).

### FIELD OF THE INVENTION

The present invention relates to a light-emitting device.

### BACKGROUND OF THE INVENTION

In modern buildings, the building elements used, for example in the ceiling, need to be compatible with various functions in relation to, for example, acoustics and lighting. An example of such a building element may be a ceiling panel with certain desired properties such as acoustic and visual properties.

When providing lighting devices for example in an acoustic panel it may be difficult to achieve uniform lighting while maintaining the desired acoustic properties. It is therefore desirable to provide an improved light-emitting panel that may provide sound-damping and uniform lighting.

### SUMMARY OF THE INVENTION

In view of the above-mentioned and other drawbacks of the prior art, a general object of the present invention is to provide an improved light-emitting device that provides uniform lighting.

According to a first aspect of the present invention there is provided a light-emitting device, comprising: an optically reflecting layer having an optically reflective side; a light-transmissive layer arranged substantially in parallel with and spaced apart from the optically reflective side of the optically reflecting layer; a light source arranged in a space between the optically reflecting layer and the light-transmissive layer; and a reflector arranged between the optically reflective side of the optically reflecting layer and the light source and configured in such a way that light emitted by the light source is reflected towards the optically reflective side of the optically reflecting layer, wherein the reflector is further configured in such a way that a fraction of the light from the light source is reflected by the reflector directly towards the light-transmissive layer.

The light-emitting device is arranged such that light received by the optically reflecting layer is emitted from the optically reflecting layer towards the light-transmissive layer.

A light source may comprise one or several lighting units. A lighting unit comprised in the light source may advantageously be a solid state lighting unit, in which light is generated through recombination of electrons and holes. Examples of solid state light sources include LEDs and semiconductor lasers.

That the light-transmissive layer may be arranged substantially in parallel with the optically reflecting layer should be interpreted as that the light-transmissive layer also may be slightly tilted with respect to the optically reflecting layer. The person skilled in the art realizes that it is not required that the light-transmissive layer is precisely in parallel with the optically reflecting layer for providing the advantageous effects of various embodiments of the invention. Furthermore, the light-transmissive layer may be planar, curved, rounded or having any other suitable shape such as a freeform shape, while still being arranged substantially in parallel with the optically reflecting layer.

The present invention is based on the realization that a light-emitting device providing uniform light may be achieved through a configuration with an optically reflecting layer and a light-transmissive layer separated by an intermediate space with a reflector arranged in the space. The surface of the optically reflecting layer facing the light-transmissive layer is optically reflective and the intermediate space acts as a mixing chamber for light reflected by the optically reflecting layer. The reflector is arranged such that light emitted by the light source is primarily directed towards the optically reflecting layer, which provides for improved uniformity of the light emitted by the light-emitting device, as well as for reduced glare. However, the reflector is further arranged and configured such that a fraction of the light emitted from the light source is directly emitted towards the light-transmissive surface. That means not all the light beams that are redirected by the reflector is redirected towards the optically reflecting layer, but some light beams are reflected by the reflector directly towards the light-transmissive layer. In this way the uniformity of the emitted light from the light transmissive layer is further improved due to a reduced contrast at a border between the reflector and the optically reflecting layer.

In various embodiments, the reflector comprises a first surface portion and a second surface portion, the second surface portion being closer to the light source than the first surface portion, wherein a fraction of light reflected towards the light-transmissive layer by the first surface portion is larger than a fraction of light reflected towards the light-transmissive layer by the second surface portion. In other words, more light, or a higher fraction of the light, emitted by the light source may be reflected directly towards the light-transmissive layer by the reflector if the emitted light is reflected from a surface portion of the reflector closer to the optically reflecting layer than if reflected from a surface portion further away from the optically reflecting layer. This way, the contrast between the reflector and the optically reflecting layer may be further reduced, which advantageously improves the uniformity further.

In some embodiments, the reflector comprises an optically specular and an optically diffusive surface portion, wherein a surface fraction of diffusive surface is increasing with increasing distance from the light source in a plane perpendicular to the light-transmissive layer. A specularly reflective surface is a surface where reflected light has a reflecting angle which is equal to the incident angle of light, contrary to a diffusive reflection where incident light having a given incident angle is reflected into a wide angular range. Accordingly, by using a diffusive surface, a fraction of light may be reflected towards the light-transmissive layer from the reflector, whereas in the case where the reflector would be specular light is only reflected towards the optically reflecting layer. A surface fraction should be understood as a part of a total surface area, such as a percentage of the total area. Here, the surface fraction of diffusive surface is the percentage of a total surface area covered by a diffusive surface. Furthermore, that a surface fraction of diffusive surface is increasing with increasing distance from the light source in a plane perpendicular to the light-transmissive layer means that the percentage of the total area which is diffusive is increasing towards the optically reflecting layer.

According to various embodiments, the reflector comprises an optically specular portion and a light redirecting surface portion configured to reflect light directly towards the light-transmissive layer, wherein a surface fraction of said light redirecting surface is increasing with increasing distance from the light source in a plane perpendicular to the light-transmissive layer. The light-redirecting surface portion may be a micro lens or reflector arranged such that it redirects nearly all reflected light directly towards the light-transmissive layer. This advantageously enables further configurations for redirecting light.

In various embodiments, the reflector may comprise optically diffusive material provided on an optically specular reflector base in a pattern with increasing surface fraction of optically diffusive material with increasing distance from the light source in a plane perpendicular to the light-transmissive layer. This advantageously enables further configurations of the reflector. For example, the diffusive properties of the diffusive material may be varied within a surface fraction of optically diffusive material. This enables a lighting condition transition from dark to bright in more than one step. The diffuse material may not have a straight edge, but for example a sine-wave edge or a wedge-shaped edge, to reduce getting a straight line at the edge between covered and uncovered base reflector.

Alternatively, the reflector comprises optically specular material provided on an optically diffusive reflector base in a pattern with decreasing surface fraction of optically specular material with increasing distance from the light source in a plane perpendicular to the light-transmissive layer.

According to further embodiments, the reflector comprises an optically specular surface comprising holes in a pattern with increasing surface fraction with increasing distance from the light source in a plane perpendicular to the light-transmissive layer, and wherein an optically diffusive material is arranged behind the optically specular surface. In this embodiment, the optically diffusive material may be arranged such that some of the light emitted by the light source is reflected by the diffusive material. The optically diffusive material may be arranged in contact with a side opposite the optically specular surface such that the holes are covered by the diffusive material. In this configuration, the optically reflecting layer may advantageously substantially follow a shape of the reflector and comprise the optically diffusive material. Alternatively, the optically reflecting layer defines the shape of the reflector. The diffusive material may for example be MCPET, Reftelas, white painted steel or a optically reflecting layer with diffusive white reflective surface. In one configuration, the specular surface may be a specular reflector film such as for example 3M ESR film, glued onto the diffusive surface, having for example a parabolic shape.

Alternatively, the reflector comprises an optically diffusive surface comprising holes in a pattern with decreasing surface density with increasing distance from the light source in a plane perpendicular to the light-transmissive layer, and wherein an optically specular material is arranged behind the optically diffusive surface. Similarly, in this configuration, the optically reflecting layer may advantageously substantially follow a shape of the reflector. In this case, the optically reflecting layer may comprise the specular surface.

The reflector may comprise a parabolic cross-section, and the light source can be arranged offset from a focal point of the reflector. Such a reflector shape provides for efficient and uniform redirection of light emitted by the light source towards the reflective surface of the optically reflecting layer. This is particularly the case if the light source is arranged offset from the focal point/line of the parabolic reflector.

According to various embodiments of the present invention, the light-transmissive layer may be an optically diffusive layer, whereby improved uniformity of the emitted light can be achieved.

According to one embodiment of the invention, the optically reflecting layer may be a sound-absorbing layer, and the light-transmissive layer may be air permeable to allow acoustic pressure waves to reach the sound-absorbing layer. The sound-absorbing layer may advantageously be made of a material capable of absorbing sound waves, such as a porous material. One example of such a porous material is glass wool. Furthermore, the sound-absorbing layer may advantageously be provided as a substantially sheet-shaped sound-absorbing layer. Moreover, the light-transmissive layer may advantageously be made of textile, paper or a non woven glass material.

Alternatively or in combination, the light-transmissive layer may be flexible to allow transmission of pressure waves substantially without air passing through the light-transmissive layer.

Moreover, according to various embodiments the light-emitting device may be configured for mounting in a ceiling. To that end, the light-emitting device may further comprise a structure for allowing attachment of the light-emitting device to the ceiling with the light-transmissive layer of the light-emitting device facing away from the ceiling.

Various embodiments of the light-emitting device according to the present invention may advantageously be comprised in a light-emitting device for mounting in a ceiling, further comprising structure for allowing attachment of the light-emitting device to the ceiling with the light-transmissive layer of the light-emitting device facing away from the ceiling.

### BRIEF DESCRIPTION OF THE DRAWINGS

These and other aspects of the present invention will now be described in more detail, with reference to the appended drawings showing exemplary embodiments of the invention, wherein:

FIG. 1 schematically shows an exemplary application for an embodiment of the light-emitting device according to the present invention;

FIG. 2 illustrates an exemplary embodiment of the light-emitting device according to the present invention;

FIGS. 3a-d illustrate exemplary reflectors according to various embodiments; and

FIG. 4 illustrates an exemplary reflector according to an embodiment.

### DETAILED DESCRIPTION OF THE EMBODIMENTS

In the following description, the present invention is mainly described with reference to a light emitting ceiling panel with integrated LED-strips arranged along the edges of the panel and reflectors directing light from the LEDs towards a reflective side of the optically reflecting layer and a fraction of the light reflected directly towards the light-transmissive layer.

It should, however, be noted that this by no means limits the scope of the invention, which is equally applicable to other applications and other lighting devices, such as light-emitting wall panels, light-emitting ceiling panels, not necessarily with the optically reflecting layer being a sound-absorbing layer. Furthermore, the light source may be any other light source such as another semiconductor light source or a fluorescent light source.

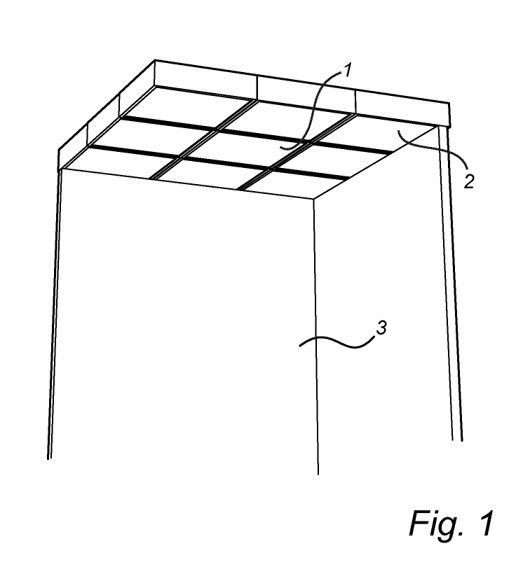

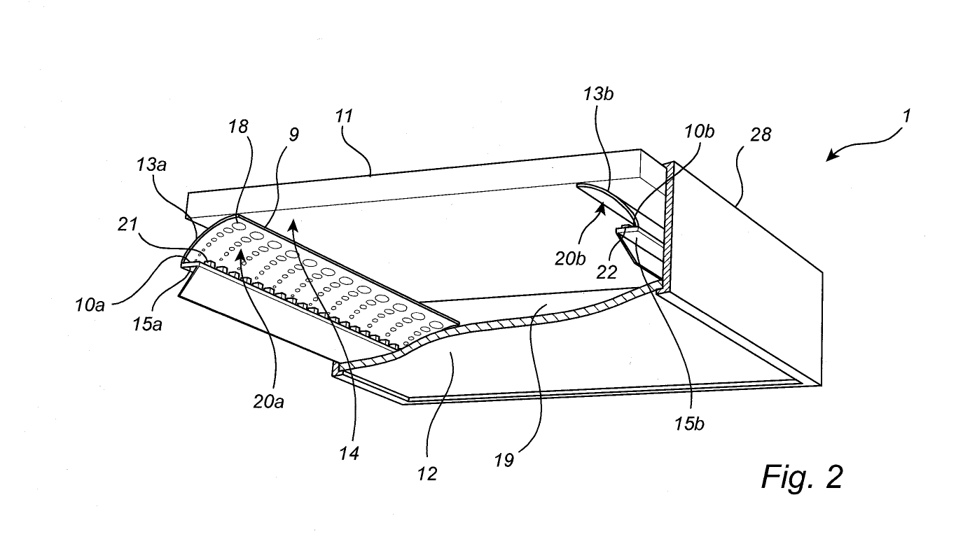

FIG. 1 schematically illustrates an exemplary application for embodiments of the light-emitting device in the form of a light-emitting panel 1 according to the present invention, arranged in a ceiling among other, conventional, ceiling panels 2 in a room 3. The configuration of the light-emitting panel 1 will now be described with reference to FIG. 2.

Referring to FIG. 2, the light-emitting panel 1 comprises a first 10a and a second light source 10b, a first 13a and a second reflector 13b, an optically reflecting layer 11 provided in the form of a sound-absorbing layer 11, and a light-transmissive layer 12. When using a sound-absorbing layer 11, the light-emitting panel 1 may be referred to as an acoustic panel.

The sound-absorbing layer 11 and the light-transmissive layer 12 are arranged in parallel such that an intermediate space 19 is formed between the sound-absorbing layer 11 and the light-transmissive layer 12. The light sources 10a-b and the reflectors 13a-b are arranged in the intermediate space 19.

The sound-absorbing layer 11, which may advantageously be formed from a sound-absorbing material such as glass wool, has an optically reflective side 14 facing the light sources 10a-b.

In the presently illustrated example embodiment, a first light source 10a comprises a plurality of light-emitting diodes (LEDs) 21 (only one of these is indicated by a reference numeral to avoid cluttering the drawing) arranged on an elongated carrier 15a. Analogously, a second light source 10b comprises a plurality of light-emitting diodes (LEDs) 22 (only one of these is indicated by a reference numeral to avoid cluttering the drawing) arranged on an elongated carrier 15b. The carriers 15a-b may, for example, be printed circuit boards, wire arrays or meshes.

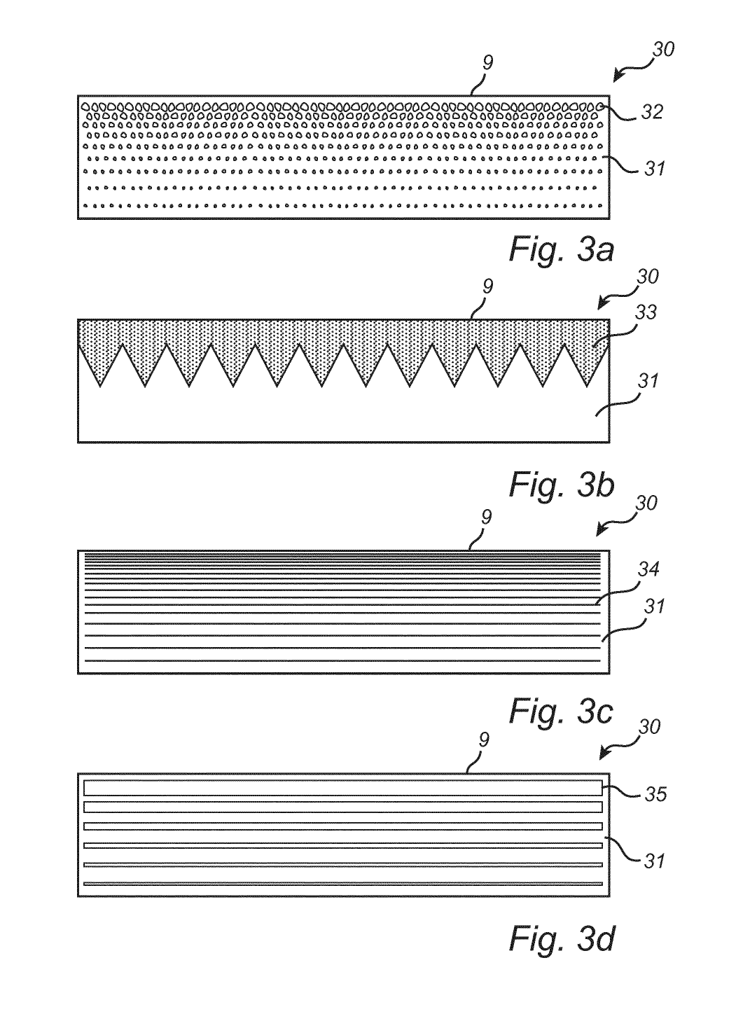

Each of the reflectors 13a, 13b has a specularly reflective surface 20a, 20b facing the light sources 10a, 10b and is arranged to primarily redirect light emitted from the light sources 10a, 10b towards the optically reflective side 14 of the sound-absorbing layer 11. The reflectors 13a, 13b each have a first end 9 (only indicated on reflector 13a) adjacent to the sound-absorbing layer. Furthermore, the reflectors each comprise optically diffusive portions 18 (only one of these is indicated by a reference numeral to avoid cluttering the drawing) on the optically specular surfaces 20a, 20b arranged such that a fraction of the emitted light is emitted directly towards the light-transmissive layer 12. The reflectors 13a-b are further arranged such that a higher fraction of the reflected light is redirected directly towards the light-transmissive layer 12 closer to the sound-absorbing layer 11 as compared to further away. The optically diffusive portions 18 may also be light redirecting surface portions 18. The reflectors will be explained further with reference to FIG. 3.

The light-transmissive layer 12 is schematically shown in FIG. 2 as a light-diffusing sheet, which may, for example, be made of a textile, paper, or glass fiber. It should, however, be noted that the light-transmissive layer 12 may be configured to perform other or further functions than to diffuse the light emitted by the LEDs 21, 22. For example, the light-transmissive layer 12 may be a prism sheet for controlling the spatial distribution of the light output by the light-emitting panel 1. It may, for example, be desirable to avoid glare. The light-transmissive layer 12 may further be configured such that it is beneficial for the acoustic performance of the light-emitting panel 1.

Finally, the light-emitting panel 1 comprises a frame 28 for fixing the relative positions of the sound-absorbing layer 11, the light-transmissive layer 12 and the light sources 10a-b, and for holding the light-emitting panel 1 together. The frame 28 may, for example, be metallic or may be made of a suitable plastic material. Reflector arrangements will now be described with reference to FIG. 3.

Referring now to FIG. 3a, a parabolic reflector 30 comprising an optically specular surface portion 31 and optically diffusive surface portions 32. The optically diffusive surface portions 32 are arranged such that a larger surface fraction of the reflector surface closer to the first end 9 adjacent to the sound-absorbing layer 11 is comprised of optically diffusive surface 32. In the illustrated embodiment, the optically diffusive portions 32 are shown in a dot pattern. However, the dots may for example be replaced by lines 35 with varying width (FIG. 3d), lines 34 with varying pitch (FIG. 3c), curved lines, freeform figures 33 (for example FIG. 3b). The diffusive portions 18, 32, 33, 34, 35 may be made from a print, or by adding a second material. For example, a diffusive material such as glass fiber fabric may be added to a specular reflector base. Furthermore, the properties of the diffusive material may vary with position on the reflector, for example, more diffusive close to the sound-absorbing layer 11, to less diffusive closer to the LEDs 22.

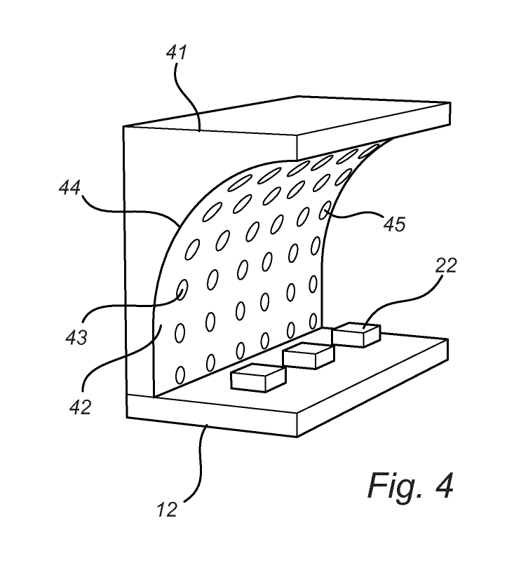

Referring now to FIG. 4, a parabolic reflector 44 comprising an optically specular surface 42 with holes 43 (only one of these is indicated by a reference numeral to avoid cluttering the drawing) arranged such that a larger surface fraction of the reflector 44 is comprised with holes further away from the LEDs 22. In the illustrated embodiment, the sound-absorbing layer 41 is formed such that it is substantially following a shape of the reflector 44. The sound-absorbing layer 41 behind the reflector 44 comprises an optically diffusive surface 45 that may receive light emitted by the LEDs 22 through the holes and redirect a fraction of the received light towards the light-transmissive layer 12. In this case, the specular surface 42 may be a specular reflector film such as a 3M ESR film glued onto an optically diffusive base. Diffusive material may for example be MCPET, Reftelas, white painted steel, or a sound-absorbing layer 41 having a diffusive white reflective surface.

Additionally, variations to the disclosed embodiments can be understood and effected by the skilled person in practicing the claimed invention, from a study of the drawings, the disclosure, and the appended claims. For example, an optical element such as a lens or a reflector may be added to the reflector and placed such that it redirects light emitted by the LEDs directly towards the light-transmissive surface. In various embodiments, instead of adding a diffusive surface portion, a diffusive reflector base may be used and specular surface portions may be added as long as a surface fraction closer to the LEDs has more specular surface portions than in a surface portion further away. For example, a diffusive surface base with holes having a specular surface behind the diffusive base covering the holes may be used. Furthermore, the shape of the sound-absorbing layer may be made to define the shape of the reflector, in particular in embodiments where holes in an optically specular or optically diffusive surface are used.

In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

1. A light-emitting device, comprising:
an optically reflecting layer having an optically reflective side;
a light-transmissive layer arranged substantially in parallel with and spaced apart from the optically reflective side of the optically reflecting layer;
a light source arranged in a space between the optically reflecting layer and the light-transmissive layer; and
a reflector arranged between the optically reflective side of the optically reflecting layer and the light source, and configured in such a way that light emitted by the light source is reflected towards the optically reflective side of the optically reflecting layer,
wherein the reflector is further configured in such a way that a fraction of the light emitted by the light source is reflected by the reflector directly towards the light-transmissive layer,
wherein the reflector comprises a first surface portion and a second surface portion, the second surface portion being closer to the light source than the first surface portion, and the first surface portion being closer to the optically reflecting layer than the second surface portion, and
wherein a fraction of light reflected towards the light-transmissive layer by the first surface portion is larger than a fraction of light reflected towards the light-transmissive layer by the second surface portion.

2. (canceled)

3. The light-emitting device according to claim 1, wherein the reflector comprises an optically specular surface portion and an optically diffusive surface portion, wherein a surface fraction of the optically diffusive surface is increasing with increasing distance from the light source in a plane perpendicular to the light-transmissive layer.

4. The light-emitting device according to claim 1, wherein the reflector comprises an optically specular surface portion and a light-redirecting surface portion configured to reflect light directly towards the light-transmissive layer, wherein a surface fraction of the light-redirecting surface is increasing with increasing distance from the light source in a plane perpendicular to the light-transmissive layer.

5. The light-emitting device according to claim 4, wherein the reflector comprises optically diffusive material provided on an optically specular reflector base in a pattern with increasing surface fraction of optically diffusive material with increasing distance from the light source in a plane perpendicular to the light-transmissive layer.

6. The light-emitting device according to claim 4, wherein the reflector comprises optically specular material provided on an optically diffusive reflector base in a pattern with decreasing surface fraction of optically specular material with increasing distance from the light source in a plane perpendicular to the light-transmissive layer.

7. The light-emitting device according to claim 4, wherein the reflector comprises an optically specular surface comprising holes in a pattern with increasing surface fraction with increasing distance from the light source in a plane perpendicular to the light-transmissive layer, and wherein an optically diffusive material is arranged behind the optically specular surface.

8. The light-emitting device according to claim 3, wherein the reflector comprises an optically diffusive surface comprising holes in a pattern with decreasing surface density with increasing distance from the light source in a plane perpendicular to the light-transmissive layer, and wherein an optically specular material is arranged behind the optically diffusive surface.

9. The light-emitting device according to claim 1, wherein the reflector is an optically specular reflector.

10. The light-emitting device according to claim 1, wherein the optically reflecting layer is substantially following a shape of the reflector.

11. The light-emitting device according to claim 1, wherein the reflector comprises a parabolic cross-section, and wherein the light source is arranged offset from a focal point of the reflector.

12. The light-emitting device according to claim 1, wherein the light source comprises a plurality of light-emitting diodes.

13. The light-emitting device according to claim 1, wherein the optically reflecting layer is a sound-absorbing layer, and wherein the light-transmissive layer is air permeable to allow acoustic pressure waves to reach the sound-absorbing layer.

14. The light-emitting device according to claim 1, wherein said reflector is an elongated reflector in a plane parallel to said light-transmissive layer.

15. The light-emitting device according to claim 1, wherein said light-transmissive layer is an optically diffusive layer.
